(19) United States
(12) Patent Application Publication
(10) Pub. No.: US 2015/0206016 A1
(43) Pub. Date: Jul. 23, 2015

(54) DRIVING IMAGE AUXILIARY SYSTEM

(71) Applicant: Primax Electronics Ltd., Taipei (TW)

(72) Inventors: HUNG-WEI CHIU, Taipei (TW); CHUN-HAO LO, Taipei (TW); YUNG-HSIEN HO, Taipei (TW)

(73) Assignee: Primax Electronics Ltd., Taipei (TW)

(21) Appl. No.: 14/252,026

(22) Filed: Apr. 14, 2014

(30) Foreign Application Priority Data
Jan. 17, 2014 (TW) 103101845

(51) Int. Cl. G06K 9/00; H04N 5/232; B60R 11/04

(52) U.S. Cl. CPC G06K 9/00791; B60R 11/04; H04N 5/23238

(57) ABSTRACT

A driving image auxiliary system includes a planar image capturing unit, a three-dimensional image building unit, a controlling unit, and a displaying unit. The controlling unit is connected with the planar image capturing unit and the three-dimensional image building unit. According to the planar image acquired by the planar image capturing unit and the three-dimensional image built by the three-dimensional image building unit, the controlling unit generates a driving auxiliary information. The displaying unit is connected with the controlling unit. After the driving auxiliary information is received by the displaying unit, a driving auxiliary image corresponding to the driving auxiliary information is shown on the displaying unit.

### FIELD OF THE INVENTION

The present invention relates to an image auxiliary system, and more particularly to a driving image auxiliary system.

### BACKGROUND OF THE INVENTION

A vehicle is one of the best mobile machines that transport passengers. When the vehicle reaches the destination, it is necessary to park the vehicle. Generally, the difficulty of reversing the vehicle is much higher than the difficulty of advancing the vehicle. Consequently, while the vehicle is reversed into a garage or parked on a roadside, the possibility of causing the collision accident is high. With the growing emphasis on driving convenience and safety, a vehicle reversing radar system or a vehicle reversing image system is gradually installed in the vehicle by more people.

Generally, the vehicle reversing radar system is located at a rear side of the vehicle. When a radar of the vehicle reversing radar system is near an object, a warning sound is generated. In the vehicle reversing image system, a display screen installed in the vehicle is used to display the image that is captured by a camera lens at a rear side of the vehicle. According to the warning sound generated by the vehicle reversing radar system and the image shown on the display screen of the vehicle reversing image system, the driver may be guided to reverse the vehicle.

However, the current vehicle reversing radar system usually has a blind corner for detection. In addition, the camera lens of the vehicle reversing image system has the following limitations. Firstly, in case that the light intensity of the environment is weak, the camera lens is unable to successfully produce the image. Under this circumstance, the image on the display screen looks very dark. Secondly, in case that the contrast of the environment is low (e.g. a snow scene), the obstacles and the land are all covered by snow and ice. Under this circumstance, the image on the display screen looks very snow-white. Thirdly, the planar (two-dimensional) image shown on the display screen fails to indicate the distance of the obstacle from the vehicle. Under this circumstance, the driver may erroneously judge the distance of the obstacle. For example, a nearby iron wire and a far wire pole shown on the display screen look very close and are difficult to be discriminated.

From the above discussions, even if the vehicle reversing radar system and the vehicle reversing image system are installed in the vehicle, the possibility of causing an accident while reversing the vehicle is high. In other words, the device and the system for assisting the driver in reversing the vehicle need to be further improved.

### SUMMARY OF THE INVENTION

The present invention relates to an image auxiliary system, and more particularly to a driving image auxiliary system integrating a planar image and a three-dimensional image.

In accordance with an aspect of the present invention, there is provided a driving image auxiliary system. The driving image auxiliary system includes a planar image capturing unit, a three-dimensional image building unit, a controlling unit, and a displaying unit. The planar image capturing unit captures a planar image of a scene. The three-dimensional image building unit builds a three-dimensional image of at least one object in the scene. The controlling unit is connected with the planar image capturing unit and the three-dimensional image building unit. The controlling unit generates a driving auxiliary information according to at least one of the planar image and the three-dimensional image. The displaying unit is connected with the controlling unit. After the driving auxiliary information is received by the displaying unit, a driving auxiliary image corresponding to the driving auxiliary information is shown on the displaying unit.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating a driving image auxiliary system according to a first embodiment of the present invention;

FIG. 2 is a schematic side view illustrating a vehicle using the driving image auxiliary system of FIG. 1;

FIG. 3 is a schematic rear view illustrating a vehicle using the driving image auxiliary system of FIG. 1;

FIG. 4 schematically illustrates a scene behind the vehicle while the vehicle is reversed into a dotted zone;

FIG. 5 schematically illustrates a planar image of the scene captured by the planar image capturing unit;

FIG. 6 schematically illustrates a panoramic three-dimensional image built by the three-dimensional image building unit;

FIG. 7 schematically illustrates a first exemplary driving auxiliary image shown on the displaying unit of the driving image auxiliary system FIG. 1;

FIG. 8 schematically illustrates a second exemplary driving auxiliary image shown on the displaying unit of the driving image auxiliary system of FIG. 1;

FIG. 9 schematically illustrates a third exemplary driving auxiliary image shown on the displaying unit of the driving image auxiliary system of FIG. 1;

FIG. 10 schematically illustrates an enlarged three-dimensional image after the driving auxiliary image shown on the displaying unit is clicked; and

FIG. 11 is a schematic functional block diagram illustrating a driving image auxiliary system according to a second embodiment of the present invention.

### DETAILED DESCRIPTION OF THE PREFERRED EMBODIMENT

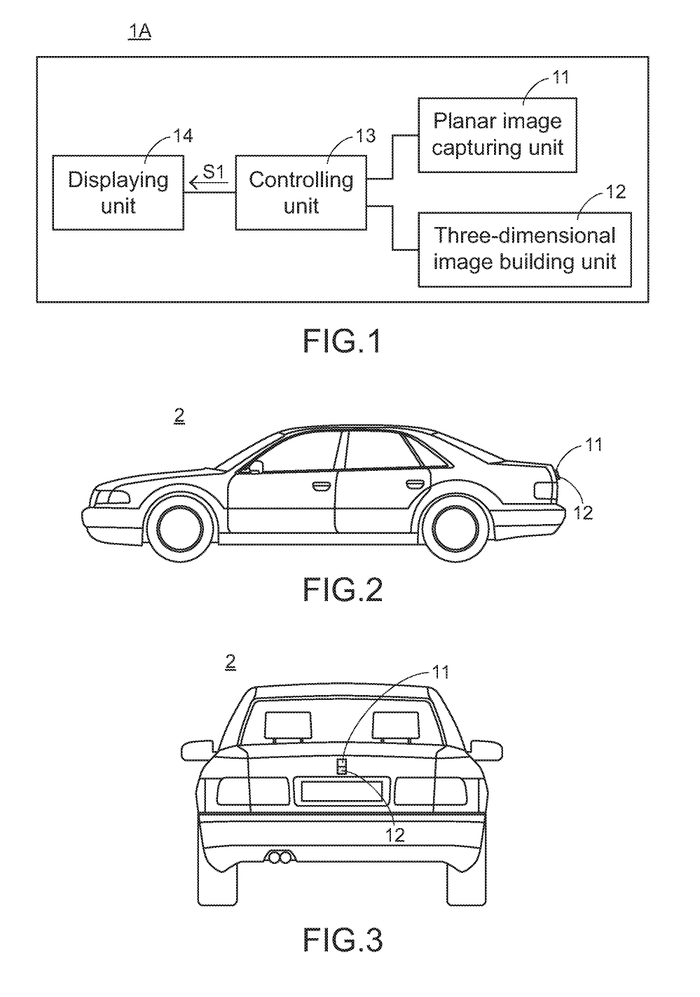

FIG. 1 is a schematic functional block diagram illustrating a driving image auxiliary system according to a first embodiment of the present invention. FIG. 2 is a schematic side view illustrating a vehicle using the driving image auxiliary system of FIG. 1. FIG. 3 is a schematic rear view illustrating a vehicle using the driving image auxiliary system of FIG. 1. As shown in FIGS. 1˜3, the driving image auxiliary system 1A comprises a planar image capturing unit 11, a three-dimensional image building unit 12, a controlling unit 13, and a displaying unit 14. The controlling unit 13 is connected with the planar image capturing unit 11, the three-dimensional image building unit 12 and the displaying unit 14.

The displaying unit 14 is disposed within the vehicle 2. The planar image capturing unit 11 and the three-dimensional image building unit 12 are located at a rear side of the vehicle 2. The planar image capturing unit 11 is used for capturing a planar image of a scene behind the vehicle 2. The three-dimensional image building unit 12 is used for scanning the scene behind the vehicle 2 in order to build a three-dimensional image of the scene behind the vehicle 2. Then, according to the planar image acquired by the planar image capturing unit 11 and the three-dimensional image built by the three-dimensional image building unit 12, the controlling unit 13 generates a driving auxiliary information S1 and issues the driving auxiliary information S1 to the displaying unit 14. Consequently, a driving auxiliary image corresponding to the driving auxiliary information S1 is shown on the displaying unit 14 to be viewed by the driver of the vehicle 2, thereby assisting the driver of the vehicle 2 to reverse the vehicle 2.

It is noted that the three-dimensional image building unit 12 is used for building point clouds of a geometric surface of an object in the scene and reconstructing a surface profile of the object. A three-dimensional image scanning technology may be in analogy with a planar image capturing technology. For the both technologies, the range of visibility is in a conical shape. As for the difference between the both technologies, the planar image capturing technology can acquire the color information, and the three-dimensional image scanning technology can acquire the distance between the three-dimensional image building unit 12 and the surface of any object in the scene. The current three-dimensional image scanning technology includes a laser scanning technology, an infrared scanning technology, an ultrasonic scanning technology, or the like. The three-dimensional image scanning technology is well known to those skilled in the art, and is not redundantly described herein.

In this embodiment, the displaying unit 14 is a LCD touch screen. Moreover, the planar image capturing unit 11 and the three-dimensional image building unit 12 are in a vertical arrangement, and approximately located at a middle region of the rear side of the vehicle 2. However, those skilled in the art will readily observe that numerous modifications and alterations may be made while retaining the teachings of the invention.

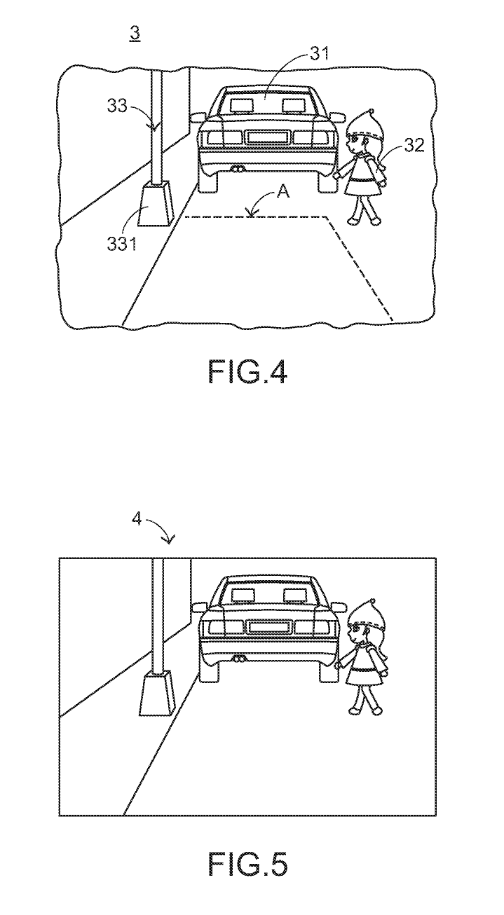

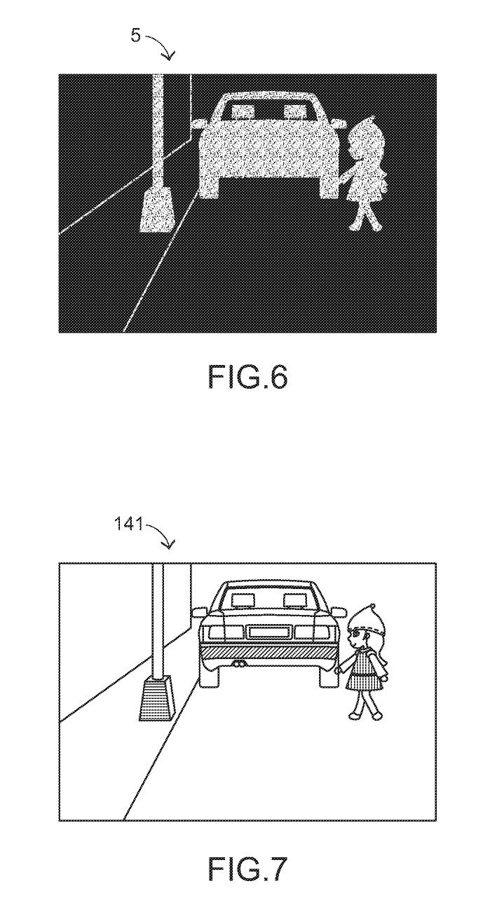

Hereinafter, the operations of the driving image auxiliary system 1A will be illustrated with reference to a scene as shown in FIGS. 4˜6. FIG. 4 schematically illustrates a scene 3 behind the vehicle 2 while the vehicle 2 is reversed into a dotted zone A. The objects (obstacles) in the scene 3 contain an additional vehicle 31, a child 32 and a street light pole 33 that are located behind the dotted zone A. FIG. 5 schematically illustrates a planar image 4 of the scene 3 captured by the planar image capturing unit 11. The planar image 4 contains the color information (not shown) of any object. FIG. 6 schematically illustrates a panoramic three-dimensional image 5 built by the three-dimensional image building unit 12. During the process of scanning the scene 3 by the three-dimensional image building unit 12, the distances between the three-dimensional image building unit 12 and the objects 31˜33 in the scene 3 are acquired, so that the panoramic three-dimensional image 5 is built.

FIG. 7 schematically illustrates a first exemplary driving auxiliary image shown on the displaying unit of the driving image auxiliary system FIG. 1. In FIG. 7, the driving auxiliary image 141 corresponding to the driving auxiliary information S1 is shown on the displaying unit 14. The driving auxiliary information S1 is generated by the controlling unit 13 according to the planar image 4 of FIG. 5 and the three-dimensional image 5 of FIG. 6. The contents of the driving auxiliary image 141 contain the colors that are superposed on the surfaces of the objects 31˜33 to indicate the distances of the objects 31˜33 from the three-dimensional image building unit 12.

For clear illustration, different colors are superposed on three regions of the driving auxiliary image 141. In FIG. 7, these colors are represented by oblique stripes, vertical stripes and horizontal stripes, respectively. In the normal situation, the colors indicative of the distances from the three-dimensional image building unit 12 are superposed on the surfaces of respective objects. In this embodiment, the regions represented by the oblique stripes, the vertical stripes and the horizontal stripes as shown in FIG. 7 indicate a red color, a green color and a blue color, respectively. Moreover, the red color, the green color and the blue color indicate the distances 600 cm, 500 cm and 400 cm, respectively. According to the colors contained in the driving auxiliary image 141, the driver may be guided to reverse the vehicle 2.

In some other embodiments, if the distance between the three-dimensional image building unit 12 at the rear side of the vehicle and any object of the scene is smaller than a default value while the vehicle 2 is reversed, the color superposed on the object of the driving auxiliary image 141 starts to flicker. The flickering color may warn the driver that the vehicle 2 is approaching the object. Consequently, the possibility of colliding with the object will be minimized. Of course, the way of warning the driver is not restricted. Those skilled in the art will readily observe that numerous modifications and alterations may be made while retaining the teachings of the invention. For example, in some embodiments, the driving image auxiliary system 1A may produce a warning sound or make a speech to prompt the user.

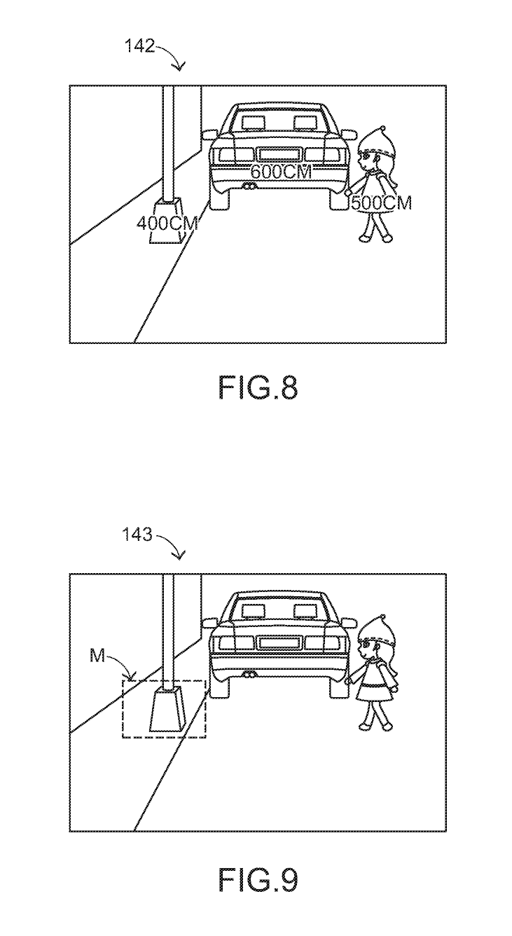

FIG. 8 schematically illustrates a second exemplary driving auxiliary image shown on the displaying unit of the driving image auxiliary system of FIG. 1. In FIG. 8, the driving auxiliary image 142 corresponding to the driving auxiliary information S1 is shown on the displaying unit 14. The driving auxiliary information S1 is generated by the controlling unit 13 according to the planar image 4 of FIG. 5 and the three-dimensional image 5 of FIG. 6. The contents of the driving auxiliary image 142 contain the tags that are superposed on the surfaces of the objects 31˜33 to indicate the distances of the objects 31˜33 from the three-dimensional image building unit 12.

For clear illustration, as shown in FIG. 8, different tags are superposed on three regions of the driving auxiliary image 142. In the normal situation, the tags indicative of the distances from the three-dimensional image building unit 12 are superposed on the surfaces of respective objects. In this embodiment, the three tags indicate the distances 600 cm, 500 cm and 400 cm, respectively. According to the tags contained in the driving auxiliary image 142, the driver may be guided to reverse the vehicle 2.

In some other embodiments, if the distance between the three-dimensional image building unit 12 at the rear side of the vehicle 2 and any object of the scene 3 is smaller than a default value while the vehicle 2 is reversed, the tag superposed on the object of the driving auxiliary image 142 starts to flicker. The flickering tag may warn the driver that the vehicle 2 is approaching the object. Consequently, the possibility of colliding with the object will be minimized. Of course, the way of warning the driver is not restricted. Those skilled in the art will readily observe that numerous modifications and alterations may be made while retaining the teachings of the invention. For example, in some embodiments, the driving image auxiliary system 1A may produce a warning sound or make a speech to prompt the user.

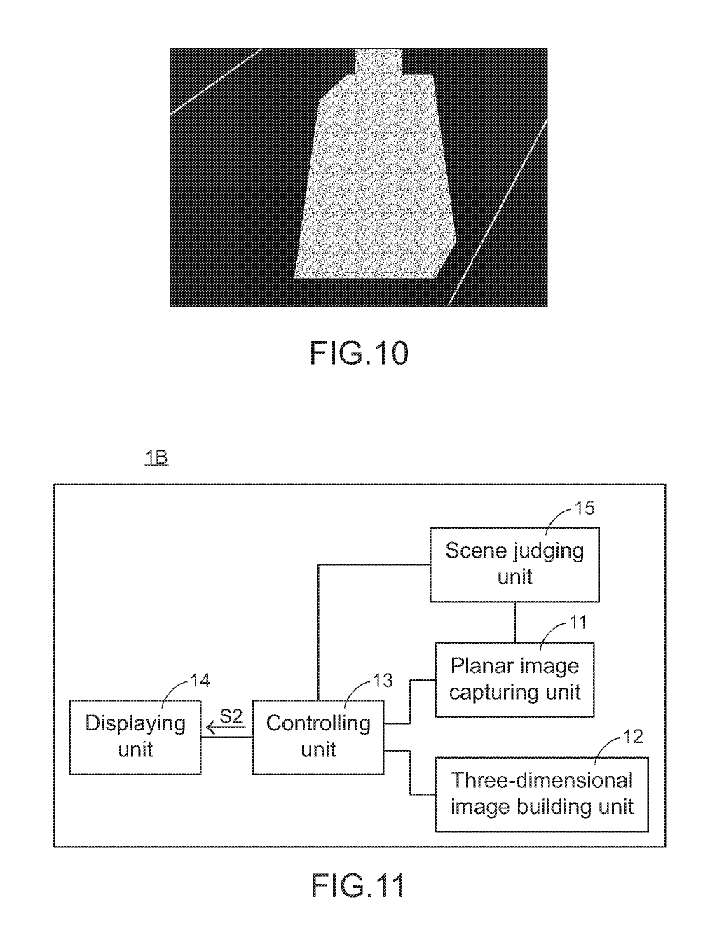

Please refer to FIGS. 9 and 10. FIG. 9 schematically illustrates a third exemplary driving auxiliary image shown on the displaying unit of the driving image auxiliary system of FIG. 1. FIG. 10 schematically illustrates an enlarged three-dimensional image after the driving auxiliary image shown on the displaying unit is clicked. In FIG. 9, the driving auxiliary image 143 corresponding to the planar image 4 of FIG. 5 is shown on the displaying unit 14. When a specified block of the driving auxiliary image 143 is clicked by the driver, an enlarged three-dimensional image 5 of the object corresponding to the specified block will be shown on the displaying unit 14.

In particular, when the dotted block M shown on the driving auxiliary image 143 of FIG. 9 is clicked, the driving auxiliary image 143 shown on the displaying unit 14 is converted into a three-dimensional image of a base 331 of the street light pole 33 and the neighboring region corresponding to the dotted block M. The three-dimensional image is shown in FIG. 10. In some embodiments, the colors or the tags for indicating the distances from the three-dimensional image building unit 12 are superposed on the surfaces of the base 331 of the street light pole 33 and the neighboring region. For clear illustration, the colors or the tags for indicating the distances are not shown in FIG. 10. The contents of the colors and tags are similar to those of the first and second exemplary driving auxiliary images, and are not redundantly described herein.

However, those skilled in the art will readily observe that numerous modifications and alterations may be made according to the practical requirements. In some embodiments, when the specified block of the driving auxiliary image 143 shown on the displaying unit 14 is clicked by the driver, the speed of scanning the specified block by the three-dimensional image building unit 12 will be increased. For example, when the dotted block M as shown in FIG. 9 is clicked, the speed of scanning the base 331 of the street light pole 33 and the neighboring region will be increased. Consequently, the speed of acquiring the distances of the base 331 of the street light pole 33 and the neighboring region from the three-dimensional image building unit 12 will be accelerated. Moreover, in some other embodiments, when the specified block of the driving auxiliary image 143 shown on the displaying unit 14 is clicked by the driver, the resolution of scanning the specified block by the three-dimensional image building unit 12 will be increased. For example, when the dotted block M as shown in FIG. 9 is clicked, the resolution of scanning the base 331 of the street light pole 33 and the neighboring region will be increased. Consequently, the accuracy and precision of acquiring the distances will be enhanced.

FIG. 11 is a schematic functional block diagram illustrating a driving image auxiliary system according to a second embodiment of the present invention. Except that the driving image auxiliary system 1B of this embodiment further comprises a scene judging unit 15, the configurations of the driving image auxiliary system 1B of this embodiment are substantially identical to those of the driving image auxiliary system 1A of the first embodiment, and are not redundantly described herein. The scene judging unit 15 is connected between the planar image capturing unit 11 and the controlling unit 13. According to the planar image 4 captured by the planar image capturing unit 11, the scene judging unit 15 may judge a scene identification level of the scene 3. In this embodiment, the scene judging unit 15 may judge the scene identification level of the scene 3 by performing an analyzing operation on the planar image 4. The analyzing operation includes but is not limited to an image spectrum analyzing operation, an image contrast analyzing operation or an image brightness analyzing operation.

If the scene judging unit 15 judges that the scene identification level of the scene 3 is low, the controlling unit 13 may drive the three-dimensional image building unit 12 to scan the scene 3 or drive the three-dimensional image building unit 12 to intensively scan a specified object of the scene 3. Moreover, according to the three-dimensional image built by the three-dimensional image building unit 12, the controlling unit 13 generates a driving auxiliary information S2. Consequently, a driving auxiliary image corresponding to the driving auxiliary information S2 is shown on the displaying unit 14. That is, if the scene identification level of the scene 3 is low, the contents of the driving auxiliary image shown on the displaying unit 14 is the panoramic three-dimensional image of the scene 3 or the three-dimensional image of the specified object in the scene.

Hereinafter, the applications of the driving image auxiliary system in some scenarios will be illustrated. Please refer to FIG. 4, which schematically illustrates the scene behind the vehicle 2 while the vehicle 2 is reversed. In a first scenario, if the brightness of the environment is lower than a default value, the planar image 4 captured by the planar image capturing unit 11 is hazy or even the contents displayed on the displaying unit 14 is completely dark. Under this circumstance, the scene judging unit 15 judges that the scene identification level of the scene 3 is low. Consequently, the controlling unit 13 may drive the three-dimensional image building unit 12 to panoramically scan the scene 3. According to the panoramic three-dimensional image 5 built by the three-dimensional image building unit 12, the controlling unit 13 generates the driving auxiliary information S2. Consequently, the driving auxiliary image corresponding to the driving auxiliary information S2 is shown on the displaying unit 14. According to the driving auxiliary image, the driver may be guided to reverse the vehicle 2.

Please refer to FIG. 4, which schematically illustrates the scene behind the vehicle 2 while the vehicle 2 is reversed. In a second scenario, the land is covered by snow, so that the planar image 4 captured by the planar image capturing unit 11 is completely snow-white. Since the image contrast of the planar image 4 is very low, the scene judging unit 15 judges that the scene identification level of the scene 3 is low. Consequently, the controlling unit 13 may drive the three-dimensional image building unit 12 to panoramically scan the scene 3. According to the panoramic three-dimensional image 5 built by the three-dimensional image building unit 12, the controlling unit 13 generates the driving auxiliary information S2. Consequently, the driving auxiliary image corresponding to the driving auxiliary information S2 is shown on the displaying unit 14. According to the driving auxiliary image, the driver may be guided to reverse the vehicle 2.

Please refer to FIG. 4, which schematically illustrates the scene behind the vehicle 2 while the vehicle 2 is reversed. In a third scenario, the child 32 within the scene 3 is running According to the image spectrum analysis, the scene judging unit 15 recognizes that there is a moving object in the scene 3. Under this circumstance, the scene judging unit 15 judges that the scene identification level of the scene 3 is low. Consequently, the controlling unit 13 may drive the three-dimensional image building unit 12 to intensively scan the child 32. For example, the speed or the resolution of scanning the child 32 is increased. Then, according to the three-dimensional image of the child 32 and the neighboring region, the controlling unit 13 generates the driving auxiliary information S2. Consequently, the driving auxiliary image corresponding to the driving auxiliary information S2 is shown on the displaying unit 14. According to the driving auxiliary image, the driver may be guided to reverse the vehicle 2.

In some embodiments, the colors or the tags for indicating the distances from the three-dimensional image building unit 12 are superposed on the surfaces of all objects (obstacles) of the driving auxiliary image. The contents of the colors and tags are similar to those of the first embodiment, and are not redundantly described herein.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A driving image auxiliary system, comprising:
a planar image capturing unit that captures a planar image of a scene;
a three-dimensional image building unit that builds a three-dimensional image of at least one object in the scene;
a controlling unit connected with the planar image capturing unit and the three-dimensional image building unit, wherein the controlling unit generates a driving auxiliary information according to at least one of the planar image and the three-dimensional image; and
a displaying unit connected with the controlling unit, wherein after the driving auxiliary information is received by the displaying unit, a driving auxiliary image corresponding to the driving auxiliary information is shown on the displaying unit.

2. The driving image auxiliary system according to claim 1, further comprising a scene judging unit, wherein the scene judging unit judges a scene identification level of the scene according to the planar image, wherein if the scene judging unit judges that the scene identification level of the scene is low, the controlling unit drives the three-dimensional image building unit to scan the at least one object of the scene, so that the three-dimensional image is acquired.

3. The driving image auxiliary system according to claim 2, wherein the three-dimensional image of at least one object is a panoramic three-dimensional image of the scene.

4. The driving image auxiliary system according to claim 2, wherein after the scene judging unit performs an image spectrum analyzing operation or an image contrast analyzing operation on the planar image, the scene identification level of the scene is judged by the scene judging unit.

5. The driving image auxiliary system according to claim 2, wherein if an environmental brightness of the scene is lower than a default value, the scene judging unit judges that the scene identification level of the scene is low.

6. The driving image auxiliary system according to claim 2, wherein if the scene is a low color contrast scene, the scene judging unit judges that the scene identification level of the scene is low.

7. The driving image auxiliary system according to claim 2, wherein if the at least one object in the scene contains a moving object, the scene judging unit judges that the scene identification level of the scene is low.

8. The driving image auxiliary system according to claim 1, wherein the driving auxiliary information contains plural distances of plural objects of the at least one object from the three-dimensional image building unit, wherein after plural colors are superposed on positions of the plural objects of the planar image, the driving auxiliary image is generated, wherein the plural colors indicate the plural distances, respectively.

9. The driving image auxiliary system according to claim 8, wherein if a specified distance of the plural distances is smaller than a default value, the color of the driving auxiliary image that indicates the specified distance starts to flicker.

10. The driving image auxiliary system according to claim 1, wherein the driving auxiliary information contains plural distances of plural objects of the at least one object from the three-dimensional image building unit, wherein after plural tags are superposed on positions of the plural objects of the planar image, the driving auxiliary image is generated, wherein the plural tags mark the plural distances, respectively.

11. The driving image auxiliary system according to claim 1, wherein the displaying unit is a touch screen, wherein when a specified block of the driving auxiliary image corresponding to the at least one object is clicked by a user, the three-dimensional image of the at least one object is shown on the displaying unit.

12. The driving image auxiliary system according to claim 11, wherein the driving auxiliary information contains at least one distance of the at least one object from the three-dimensional image building unit, wherein after at least one color is superposed on the three-dimensional image of the at least one object, the driving auxiliary image is generated, wherein the at least one color indicates the at least one distance.

13. The driving image auxiliary system according to claim 11, wherein the driving auxiliary information contains at least one distance of the at least one object from the three-dimensional image building unit, wherein after at least one tag is superposed on the three-dimensional image of the at least one object, the driving auxiliary image is generated, wherein the at least one tag marks the at least one distance.

14. The driving image auxiliary system according to claim 1, wherein when a specified block of the driving auxiliary image corresponding to the at least one object is clicked by a user, the three-dimensional image building unit increases a speed of scanning the at least one object, thereby accelerating a speed of acquiring plural distances of the at least one object from the three-dimensional image building unit.

15. The driving image auxiliary system according to claim 1, wherein when a specified block of the driving auxiliary image corresponding to the at least one object is clicked by a user, the three-dimensional image building unit increases a resolution of scanning the at least one object.

16. The driving image auxiliary system according to claim 1, wherein the at least one object is scanned by the three-dimensional image building unit according to a laser scanning technology, an infrared scanning technology or an ultrasonic scanning technology.
